(19) United States
(12) Patent Application Publication
(10) Pub. No.: US 2008/0174262 A1
(43) Pub. Date: Jul. 24, 2008

(54) Method of powering a single-phase electric motor and a power supply system for implementing such a method

(75) Inventor: Ali Makki, Lyon (FR)

Correspondence Address: OLIFF & BERRIDGE, PLC, P.O. BOX 320850, ALEXANDRIA, VA, 22320-4850, US

(73) Assignee: MOTEURS LEROY-SOMER, ANGOULEME (FR)

(21) Appl. No.: 12/010,166

(22) Filed: Jan. 22, 2008

(30) Foreign Application Priority Data
Jan. 23, 2007 (FR) 07 52828

(51) Int. Cl. H02P 1/42; H02P 27/08

(52) U.S. Cl. 318/778; 318/812

(57) ABSTRACT

The present invention relates to a method of powering a single-phase asynchronous electric motor, comprising first and second windings, in which method one of the windings is powered by AC mains while the other winding is powered by an inverter that receives a rectified voltage from the mains and that is controlled in such a manner that said second winding is powered with a voltage of waveform that is offset relative to that from the mains.

The present invention relates to powering single-phase asynchronous electric motors.

Single-phase asynchronous motors present the peculiarity of not starting spontaneously.

It is thus known to provide single-phase asynchronous motors with two windings and to use a starter element for creating an electrical phase offset in the current of one of the windings relative to the other in order to obtain a starting torque.

The best starting torque is obtained when the two respective magnetic fields associated with the windings of the motor are at a phase offset of 90° electrical.

The starter element that is in most widespread use is a capacitor.

The ideal phase offset of 90° electrical is never achieved when using such a starter element, given the existence of induction and resistance in the phase that is in series with the capacitor, thereby lowering the starting torque, which can not reach the nominal torque of the motor.

When the required starting torque exceeds the nominal torque of the motor, it is known to add an additional capacitor together with a switch member such as a relay for taking the additional capacitor out of circuit once the motor has reached its maximum torque.

It is nevertheless not desirable to use a capacitor of high capacitance, since that can lead to a large increase in current with excessive heating associated with an increase in losses.

International application WO 2005/057773 discloses a starter system for a single-phase induction motor in which the two motor windings are connected in series respectively with two electronic switches that are controlled with a mutual phase offset while the motor is starting. The starting winding ceases to be powered once the motor has started. Such a system is relatively complex, and in addition it requires accurate control over the switching instant of each electronic switch.

The invention seeks to further improve methods and systems for electrically powering single-phase asynchronous motors.

Examplary embodiments of the invention achieve this by means of a method of powering a single-phase asynchronous electric motor, comprising first and second windings, in which method one of the windings is powered by AC mains while the other winding is powered by an inverter that receives a rectified voltage from the mains and that is controlled in such a manner that said second winding is powered with a voltage of waveform that is offset relative to that from the mains, the phase offset preferably being 90° electrical, at least during starting.

The invention makes it possible to obtain high starting torque without using a starting capacitor of large capacitance and without using any associated switching member.

The invention may enable a higher starting speed to be obtained and may thus enable starting time to be shortened, and it may also enable current under nominal conditions to be reduced, thereby enabling the power of the motor to be increased or else enabling its size to be reduced at identical power.

Energy consumption on starting may be reduced.

Any danger associated with using a starting element constituted by a capacitor may also be eliminated.

Where appropriate, the invention may also make it possible to eliminate the permanent capacitor that is generally to be found in single-phase asynchronous motors.

The invention may enable both phases of the motor to be powered continuously. This makes it possible to make best use of the performance of the motor, since the magnetic and electrical circuits of the motor are used to the full.

Where appropriate, the phase powered by the inverter may be switched off after starting, to the detriment of the power the motor can deliver.

The first winding may be directly powered by AC mains without an intermediate electronic switch, for example without a semiconductor-type switch.

The windings of the motor may be constituted by the first and second windings only.

The second winding may include only two terminals, each terminal being connected to one output of the inverter.

The second winging is for instance different from a split winding constituted by two half-windings, wherein each half-winding has a first terminal connected to one output of the inverter and a second terminal connected to the second terminal of the other half-winding by a center tap connected to the output of the rectifier.

In exemplary embodiments of the invention, the phase offset is constant and substantially equal to 90° electrical, e.g. with a tolerance of ±5%. In a variant, the phase offset may be modified after starting so as to act on the speed of the motor under nominal conditions.

The amplitude of the voltage delivered by the inverter may be constant. In a variant, this amplitude is modified in order to act on the speed of the motor.

If so desired, the power supply system makes it possible to have three modes for controlling the speed of the motor. A first mode involves variation by varying the phase offset, a second by varying the amplitude of the voltage, and a third by varying both the amplitude and the phase offset.

By way of example, the amplitude and/or the phase offset may be modified as a function of a setpoint speed and as a function of the speed of the motor as measured, for example, by a speed sensor, so as to tend to keep the motor speed equal to the setpoint value.

In an embodiment of the invention, the inverter may be controlled as a function of detecting an extremum in the mains voltage waveform, e.g. a maximum.

In another embodiment of the invention, the inverter may be controlled as a function of detecting a zero crossing in the mains voltage waveform.

In particular, when the inverter is programmable and it generates a voltage of waveform having a zero value at the instant when operation thereof is triggered, the inverter may be controlled by a signal that is delayed by 1/(4*f) where f is the frequency of the mains voltage, where the delay is measured from a zero crossing in the mains voltage waveform.

The first and second windings may be identical or they may be different.

The use of a motor presenting identical windings may be advantageous in terms of production and control, since for control purposes, an accurate phase offset may be generated without it being necessary to know accurately electrical parameters of the windings, such as their resistances and inductances. If the windings are different, the phase offset may be calculated as a function of the differences between their electrical parameters. On starting, Ohm's law applies, and it can be assumed that U=Z*I, where Z is the total impedance comprising both the induction and the resistance of a phase. The phase offset of the current relative to the voltage is a function of the induction and of the resistance. The ratio L1/R1 of the first phase defines the delay (phase offset α1) of the current I1 relative to the voltage U1. The ratio L2/R2 of the second phase defines the delay (phase offset α2) of the current I2 relative to the voltage U2. If α1 is not equal to α2, it may be desirable to advance or to retard the instant at which power is applied to the second phase. If α2−α1 is less than zero, then the powering of the second phase may be retarded, while if α2−α1 is greater than zero, then it may be advanced. The advance or retard duration may be proportional to α2-α1. If the phases are identical, then α2-α1=0.

Other exemplary embodiments of the invention also provide a power supply system for a single-phase asynchronous electric motor having first and second windings, the system comprising:
an input connected to an alternating mains network;
a first output connected to the input of the system and for connection to the first winding of the motor;
a second output for connection to a second winding of the motor;
an inverter connected to the input of the system via a rectifier and connected to the second output; and
an inverter control unit configured to act on the operation of the inverter in such a manner that the voltage waveform delivered by the inverter to the second output is offset by a phase of magnitude that is predefined relative to the mains voltage waveform, the phase offset preferably being equal to 90° electrical, at least on starting the motor.

The control unit may be arranged to detect an extremum in the mains voltage waveform and to control the inverter as a function of detecting said extremum.

In a variant, the control unit may be arranged to detect a zero crossing in the mains voltage waveform and to control the inverter as a function of said detection.

The control unit may include a time delay for retarding a control signal issued on a zero crossing in the voltage waveform, with the inverter being controlled as a function of retarded signal.

By way of example, the inverter may be of the pulse width modulated (PWM) type. Such an inverter enables a waveform to be obtained that is very close to being sinusoidal. Its duty ratio may be constant, or variable if it is desired to vary the speed of the motor, for example. Switching modes other than PWM may be used, where appropriate.

Where appropriate, the control unit may be arranged to act on the amplitude and/or the phase offset of the voltage delivered by the inverter as a function of a setpoint speed and as a function of a signal representative of the speed of the motor.

Other exemplary embodiments of the invention also provide an assembly comprising a power supply system as defined above and a single-phase asynchronous electric motor having its first and second windings connected respectively to the first and second outputs of the control system.

The invention can be better understood on reading the following detailed description of non-limiting implementations thereof, and on examining the accompanying drawings, in which:

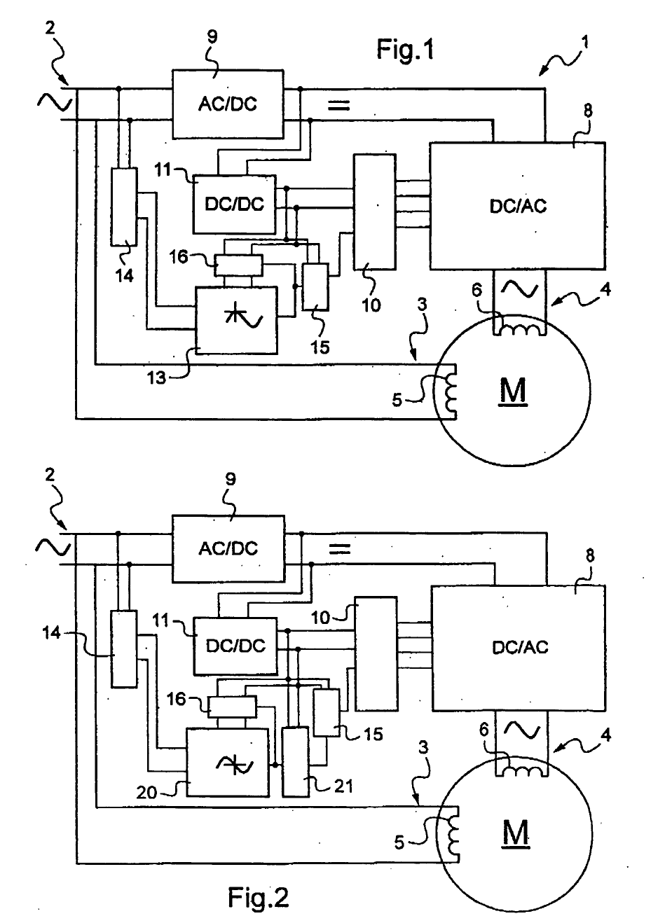

FIG. 1 is a block diagram of an example of an installation of the invention;

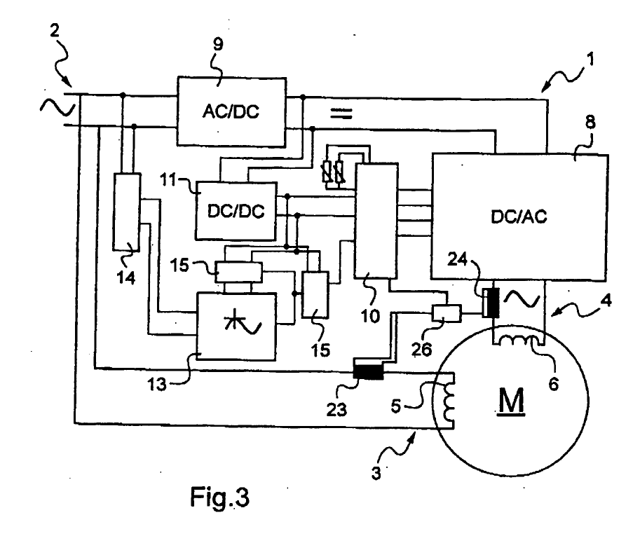

FIGS. 2 and 3 are block diagrams of other examples of installations of the invention.

The power supply system 1 of the invention that is shown in FIG. 1 has an input 2 for connecting to the mains electricity network, e.g. at 240 volts (V) and 50 hertz (Hz) or at 110 V and 60 Hz, and two outputs 3 and 4 for connecting respectively to two windings 5 and 6 of a single phase asynchronous electric motor M, these windings 5 and 6 being associated respectively with a first phase and with a second phase of said motor M. The windings 5 and 6 may be identical.

The term “identical” should be understood as meaning that both windings have the same number of turns and wires of the same diameter and that they occupy the same number of slots. For example, with a stator having 24 slots, the first winding occupies 12 slots and the second winding occupies the other 12 slots.

It is possible for the winding configuration to be non-symmetrical, for example for the winding of the first phase to occupy ⅔ of the total number of slots, while the second winding occupies ⅓ of the total number of slots. Under such circumstances, in order to obtain better starting torque, it is possible to vary the amplitude of the voltage of the phase delivered by the inverter. The magnetic field is obtained by the product N*I, where N is the number of turns per phase and I is the current in the phase. The best field is obtained when N1*I1 for the first phase is equal to N2*I2 for the second phase and when the currents are at a phase offset of 90° electrical. If N1>N2 and the currents I1 and I2 are offset by 90° electrical, then it is possible to act on the amplitude of the voltage of phase 2 in order to obtain I1=I2. Under such circumstances, the voltage U2 is proportional to N2*U1/N1, thereby giving ideal conditions for having the best starting torque.

The output 3 is connected directly to the input 2. The term “directly” should be understood as meaning that the winding 5 is powered by the mains. At least one fuse or overcurrent protector member or a current-measuring shunt may optionally be present in the line connecting the input 2 to the output 3.

By way of example, the output 4 is connected to a PWM type inverter 8, also known as a DC/AC converter, that is powered with rectified current via a rectifier 9 connected to the input 2.

The inverter 8 is controlled by a control unit that comprises a controller 10 for controlling the power components of the inverter 8, and a low voltage power supply 11. By way of example, the inverter 8 comprises four power components in an H-bridge configuration, in known manner.

By way of example, the power supply 11 comprises a DC/DC converter powered from the DC bus at the output from the rectifier 9.

In the example of FIG. 1, the control unit also includes a peak detector 13 for detecting the peak in the mains voltage waveform, receiving as its input a voltage waveform that is not offset relative to that of mains, and that is delivered via a voltage divider 14.

The control unit may also include a component 15 connected to the controller 10 in order to deliver an order to switch on the inverter 8, and a component 16 for disconnecting the detector 13 once peak detection has been performed in order to reduce the electricity consumption of the control unit and in order to avoid sending signals from the detector 13 to the component 15 repeatedly.

The term “component” should be understood functionally and covers any electronic circuit capable of performing the desired function, possibly in software. The component 15 is shown as being separate from the controller 10 and the detector 13, but it could be implemented otherwise. The same applies to the component 16.

The controller 10 controls the inverter 8 to deliver a sinusoidal voltage waveform to the output 4 that is offset by 90° electrical relative to the mains voltage waveform.

The system of FIG. 1 operates as follows.

The output 3 powers the winding 5 continuously. When the mains voltage waveform passes through a maximum that causes the inverter to be put into operation, which then generates a voltage waveform starting from zero, i.e. with an offset of 90° electrical. The detector 13 is switched off after this detection by the component 16.

The variant of FIG. 2 differs from the example of FIG. 1 in that the detector 13 is replaced by a detector 20 that detects a zero crossing in the mains voltage waveform and in that the component 15 receives the signal from the detector 20 after it has been retarded by a magnitude of 1/(4*f) by a time delay 21.

The operation of the FIG. 2 power supply system is as follows.

The output 3 powers the winding 5 with mains voltage continuously. When the mains voltage waveform passes through zero, the detector 20 generates a corresponding signal that is delayed by 1/(4*f) before acting via the component 15 to cause the inverter 8 to operate. The inverter delivers a sinusoidal voltage that is offset by 90° electrical relative to mains.

On detecting a zero crossing in the mains waveform, the component 16 disconnects the detector 20, thereby preventing orders from being sent by the detector 20 to the component 15.

As shown in FIG. 3, it is possible to add to the installation of either one of FIGS. 1 and 2 a system for synchronizing on the mains waveform. This may be done for example with the help of two shunts 23 and 24 connected in series with the outputs 3 and 4 respectively and delivering images of the currents they deliver to a comparator 26. The comparator is connected to the controller 10, which is arranged to synchronize the voltage at the output 4 on the mains voltage waveform.

Naturally, the invention is not limited to the examples described.

For example, the time reference used for controlling the inverter to operate with a predefined offset may be determined other than by detecting a zero crossing or a passage via an extremum in the mains voltage, for example by detecting passage through a predefined voltage or by detecting a particular slope for voltage variation.

The component that disconnects the detector of an extremum or of a zero crossing in the mains voltage waveform may be omitted, where appropriate. Under such circumstances, the corresponding information is delivered periodically to the controller of the inverter.

In a variant, the time delay 21 in the example of FIG. 2 is omitted and a programmable controller 10 is used, thereby making it possible to calculate a delay and cause a sinusoidal voltage waveform to be delivered at a desired phase offset.

Where appropriate, the power supply system may be used for controlling the speed of the motor, by controlling the amplitude of the voltage that is delivered by the inverter.

Independently or in combination with the above, exemplary embodiments of the invention also provide a method of controlling the speed of a single-phase asynchronous motor in which action is taken in a power supply system where one of the phases of the motor is connected to mains, to vary the amplitude of the voltage delivered by the inverter to the other phase in order to control the speed of the motor. For example, it is possible to act on the amplitude of the voltage by modifying the duty ratio when the inverter 8 is of the PWM type, for example.

FIG. 3 shows two variable resistances connected to the controller 10. For example, these comprise one resistance for modifying the amplitude of the voltage delivered by the inverter, and another resistance for varying the phase offset of the voltage delivered by the inverter relative to mains voltage. This may enable the power supply system to be adjusted as a function of a motor having windings that are not identical, for example.

The expression “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method of powering a single-phase asynchronous electric motor, comprising first and second windings, wherein one of the windings is powered by AC mains while the other winding is powered by an inverter that receives a rectified voltage from the mains and that is controlled in such a manner that said second winding is powered with a voltage of waveform that is offset relative to that from the mains.

2. A method according to claim 1, the phase offset being 90° electrical, ±5%, at least when starting the motor.

3. A method according to claim 1, the inverter being controlled as a function of detecting a voltage maximum in the mains voltage waveform.

4. A method according to claim 1, the inverter being controlled as a function of detecting a zero crossing in the mains voltage waveform.

5. A method according to claim 4, the inverter being controlled by a signal that is delayed by 1/(4*f) starting from a zero crossing in the mains voltage waveform, and where f is the frequency of the mains voltage.

6. A method according to claim 1, the first and second windings being identical.

7. A method according to claim 1, wherein the currents in the windings are compared and wherein the inverter is controlled in such a manner as to synchronize the voltage delivered by the inverter with the mains waveform.

8. A method according to claim 1, wherein the amplitude of the inverter voltage is modified as a function of a setpoint speed and as a function of a signal representative of the speed of the motor.

9. A method according to claim 1, wherein the phase offset is modified as a function of a setpoint speed and as a function of a signal representative of the speed of the motor.

10. A method according to claim 2, the phase offset being constant.

11. A method according to claim 1, wherein the inverter is subjected to modulation of the PWM type, and wherein the duty ratio is varied in order to vary speed.

12. A method according to claim 1, the windings being powered continuously.

13. A power supply system for a single-phase asynchronous electric motor having first and second windings, the system comprising:
an input connected to an alternating mains network;
a first output connected to the input of the system and for connection to the first winding of the motor;
a second output for connection to a second winding of the motor;
an inverter connected to the input of the system via a rectifier and connected to the second output; and
an inverter control unit configured to act on the operation of the inverter in such a manner that the voltage waveform delivered by the inverter to the second output is offset by a phase of magnitude that is predefined relative to the mains voltage waveform, the phase offset preferably being equal to 90° electrical, at least on starting the motor.

14. A system according to claim 13, the phase offset being 90° electrical ±5%.

15. A system according to claim 13, the control unit including a detector arranged to detect an extremum in the mains voltage waveform and to control the inverter as a function of detecting said extremum.

16. A system according to claim 13, the inverter control unit including a detector arranged to detect a zero crossing in the mains voltage waveform and to control the inverter as a function of said detection.

17. A system according to claim 16, the inverter control unit including a time delay for delaying the signal corresponding to the zero crossing in the voltage waveform and for controlling the inverter as a function of said delayed signal.

18. A system according to claim 15, including a component for disconnecting the detector once detection has been performed.

19. A system according to claim 13, the control unit being arranged to modify the amplitude of the voltage delivered by the inverter as a function of a setpoint speed and as a function of the speed as measured or estimated.

20. A system according to claim 13, the control unit being arranged to modify the phase offset as a function of a setpoint speed and as a function of the speed as measured or estimated.

21. An assembly comprising a power supply system as defined in claim 13 and a single-phase asynchronous electric motor having its first and second windings connected respectively to the first and second outputs of the control system.

22. An assembly according to claim 21, the first and second windings being identical.
